(19) United States
(12) Patent Application Publication
(10) Pub. No.: US 2019/0385547 A1
(43) Pub. Date: Dec. 19, 2019

(54) CONTROL CIRCUIT OF DISPLAY PANEL, DISPLAY DEVICE AND CONTROL METHOD THEREOF

(71) Applicants: HKC CORPORATION LIMITED, GUANGDON (CN); CHONGQING HKC OPTOELECTRONICS TECHNOLOGY CO., LTD., CHONGQING (CN)

(72) Inventor: Yu-jen Chen, Taiwan (CN)

(73) Assignees: HKC CORPORATION LIMITED, GUANGDON (CN); CHONGQING HKC OPTOELECTRONICS TECHNOLOGY CO. LTD., CHONGQING (CN)

(21) Appl. No.: 15/556,358

(22) PCT Filed: May 10, 2017
(86) PCT No.: PCT/CN2017/083746

§ 371 Date: Nov. 28, 2018

(30) Foreign Application Priority Data
Apr. 19, 2017 (CN) 201710257951.0

(51) Int. Cl. G09G 3/36

(52) U.S. Cl. CPC G09G 3/3648

(57) ABSTRACT

A control circuit of a display panel, a display device, a control method are provided. The control circuit includes a communication bus, a display control circuit, at least one of a first switch and a second switch. The communication bus includes a clock signal line and a data signal line. The display control circuit has a first signal input terminal electrically connected to the clock signal line, a second signal input terminal electrically connected to the data signal line, a signal output terminal electrically connected to the display drive circuit. The first switch is disposed between the first signal input terminal and the clock signal line with a first control terminal being electrically connected to a first control signal line, the second switch is disposed between the second signal input terminal and the data signal line with a second control terminal being electrically connected to a second control signal line.

### TECHNICAL FIELD

The present disclosure relates to the field of display technology, particularly to a control circuit of a display panel, a display device and a control method thereof.

### BACKGROUND

With the development of display panels, Thin Film Transistor (TFT) display panels have become important display platforms among various electronic products. A TFT display panel includes a plurality of TFTs, where each of the plurality of TFTs is electrically connected to a respective one of corresponding pixel units in the display panel, and the display panel may control the plurality of TFTs through a driver chip disposed in a non-display area of the display panel, so as to control pixel units in a display area of the display panel, thereby controlling a display function of the display panel.

When adjusting preset parameters in the display panel, that is, writing data to the display panel, the driver chip is required to be electrically connected to a communication bus outside the display panel, and then data is written to the display panel through the driver chip using the communication bus. When the writing is finished using the communication bus, the display panel calls the written data so that the display panel is controlled.

As the communication bus outside the display panel is generally disposed on a system board, when the communication bus finishes writing data to the driver chip, a part of resistors and capacitors on the system board affect, through the communication bus, control of the display panel by the driver chip, causing the display panel to work abnormally or even stop working.

### SUMMARY

The present disclosure provides a control circuit of a display panel, a display device and a control method thereof capable of avoiding the following phenomena: after the communication bus finishes writing data to the display control module, resistors and capacitors connected to the communication bus affect the control of a display control module over a display drive circuit, causing the display panel to work abnormally or even stop working.

According to a first aspect, the present disclosure provides a control circuit of a display panel, including: a communication bus, a display control circuit, a display drive circuit and at least one of a first switch and a second switch, where

the communication bus includes a clock signal line and a data signal line;

the display control circuit has a first signal input terminal, a second signal input terminal and a signal output terminal, the first signal input terminal is electrically connected to the clock signal line, the second signal input terminal is electrically connected to the data signal line, and the signal output terminal is electrically connected to the display drive circuit; and

the first switch is disposed between the first signal input terminal and the clock signal line with a first control terminal of the first switch being electrically connected to a first control signal line, and the second switch is disposed between the second signal input terminal and the data signal line with a first control terminal of the second switch being electrically connected to a second control signal line.

According to a second aspect, the present disclosure provides a display device, including: a display panel, a control circuit of the display panel and a display drive circuit, where the control circuit of the display panel includes a communication bus, a display control circuit, a display drive circuit and at least one of a first switch and a second switch. The communication bus includes a clock signal line and a data signal line. The display control circuit has a first signal input terminal, a second signal input terminal and a signal output terminal. The first signal input terminal is electrically connected to the clock signal line, the second signal input terminal is electrically connected to the data signal line, and the signal output terminal is electrically connected to the display drive circuit. The first switch is disposed between the first signal input terminal and the clock signal line with a first control terminal of the first switch being electrically connected to a first control signal line, and the second switch is disposed between the second signal input terminal and the data signal line with a first control terminal of the second switch being electrically connected to a second control signal line. The display drive circuit includes a plurality of source drive circuits and a plurality of gate drive circuits, where each of the plurality of source drive circuits has a plurality of input terminals and a plurality of output terminals. The plurality of input terminals of each of the plurality of source drive circuits are electrically connected to the display control circuit, and a part of output terminals of each of the plurality of source drive circuits are electrically connected to a corresponding gate drive circuit through wires in a non-display area of the display panel.

According to a third aspect, the present disclosure provides a control method of a display device, where the display device includes a display panel, a control circuit of the display panel and a display drive circuit, where

the control circuit of the display panel includes a communication bus, a display control circuit, the display drive circuit and at least one of a first switch and a second switch, the communication bus includes a clock signal line and a data signal line; the display control circuit has a first signal input terminal, a second signal input terminal and a signal output terminal, the first signal input terminal is electrically connected to the clock signal line, the second signal input terminal is electrically connected to the data signal line, and the signal output terminal is electrically connected to the display drive circuit; and the first switch is disposed between the first signal input terminal and the clock signal line with a first control terminal of the first switch being electrically connected to a first control signal line, and the second switch is disposed between the second signal input terminal and the data signal line with a first control terminal of the second switch being electrically connected to a second control signal line;

the display drive circuit includes a plurality of source drive circuits and a plurality of gate drive circuits, each of the plurality of source drive circuits has a plurality of input terminals and a plurality of output terminals, the plurality of input terminals of each of the plurality of source drive circuits are electrically connected to the display control circuit, and a part of output terminals of each of the plurality of source drive circuits are electrically connected to a corresponding gate drive circuit through wires in a non-display area of the display panel;

the control method includes at least one of the following operations:

when writing data to the display control circuit by the communication bus, controlling the first switch to be turned on with the first control signal line so as to output a clock signal to the display control circuit; and controlling the first switch to be turned off with the first control signal line when the communication bus finishes writing data to the display control circuit; and when writing data to the display control circuit by the communication bus, controlling the second switch to be turned on with the second control signal line so as to output a data signal to the display control circuit; and controlling the second switch to be turned off with the second control signal line when the communication bus finishes writing data to the display control circuit.

According to a fourth aspect, the present disclosure provides a control circuit of a display panel, including: a first switch, a second switch, a communication bus, a display control circuit and a display drive circuit, where

the communication bus includes a clock signal line and a data signal line;

the display control circuit includes a first signal input terminal, a second signal input terminal and a signal output terminal, where the first signal input terminal is electrically connected to the clock signal line, the second signal input terminal is electrically connected to the data signal line, and the signal output terminal is electrically connected to the display drive circuit;

the first switch is disposed between the first signal input terminal and the clock signal line with a first control terminal of the first switch being electrically connected to a first control signal line, and the second switch is disposed between the second signal input terminal and the data signal line with a first control terminal of the second switch being electrically connected to a second control signal line; and

the first switch and the second switch each include an Insulated Gate Field-Effect Transistor (IGFET), where the first control terminal of the first switch and the first control terminal of the second switch are gates of the IGFET, a first input terminal of the first switch and a first output terminal of the first switch are a source of the IGFET and a drain of the IGFET respectively, and a first input terminal of the second switch and a first output terminal of the second switch are a source of the IGFET and a drain of the IGFET respectively.

The present disclosure provides a control circuit of a display panel, a display device and a control method thereof, where the control circuit of the display panel includes a communication bus, a display control circuit, a display drive circuit and at least one of a first switch and a second switch, where the communication bus includes a clock signal line and a data signal line; the display control circuit includes a first signal input terminal electrically connected to the clock signal line, a second signal input terminal electrically connected to the data signal line and a signal output terminal electrically connected to the display drive circuit; and the first switch is disposed between the first signal input terminal and the clock signal line with a first control terminal of the first switch being electrically connected to a first control signal line, and the second switch is disposed between the second signal input terminal and the data signal line with a first control terminal of the second switch being electrically connected to a second control signal line. The first switch can be used to control connection and disconnection between the clock signal line in the communication bus and the display control circuit and the second switch can be used to control connection and disconnection between the data signal line in the communication bus and the display control circuit. That is, the first switch and the second switch can be used to cut off the communication between the communication bus and the display control circuit after the communication bus finishes writing data to the display panel, which avoids the phenomena that after the communication bus finishes writing data to the display control circuit, resistors and capacitors connected to the communication bus affect the control of the display control module over the display drive circuit and further cause the display panel to work abnormally or even stop working.

### BRIEF DESCRIPTION OF DRAWINGS

To illustrate technical solutions of the following embodiments more clearly, the accompanying drawings used in the description of the embodiments will be described below.

FIG. 1 is schematic structural diagram 1 of a control circuit of a display panel according to an embodiment.

FIG. 2 is schematic structural diagram 2 of a control circuit of a display panel according to an embodiment.

FIG. 3 is schematic structural diagram 3 of a control circuit of a display panel according to an embodiment.

FIG. 4 is a schematic structural diagram of a display device according to an embodiment.

FIG. 5 is a schematic flowchart of a control method of a display device according to an embodiment.

### DETAILED DESCRIPTION

The technical solutions of the present disclosure will be described clearly and completely with reference to the accompanying drawings through illustrative embodiments from which the technical solutions will be apparent. The embodiments described below are part, not all, of the embodiments of the present disclosure.

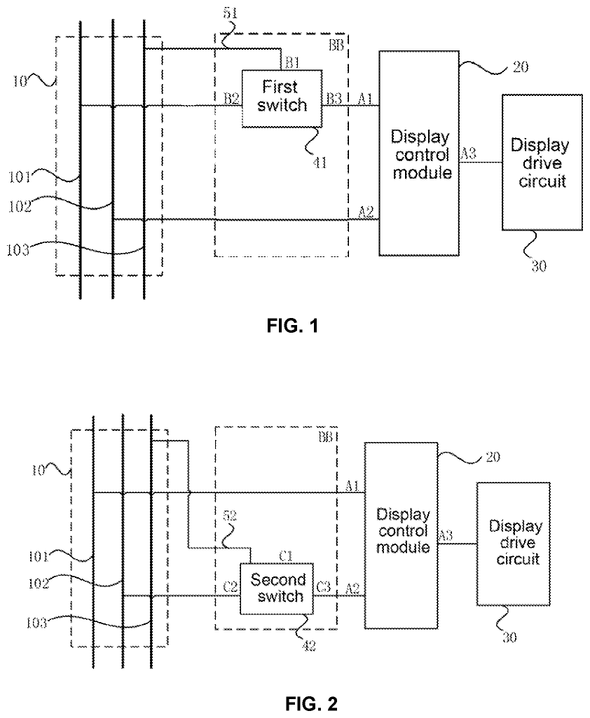

FIG. 1 is a schematic structural diagram of a control circuit of a display panel according to the present embodiment. Referring to FIG. 1, the control circuit of the display panel includes a communication bus 10, a display control module (also referred to as display control circuit) 20, a display drive circuit 30, a first switch 41 and a second switch 42. The communication bus 10 includes a clock signal line 101 and a data signal line 102. The display control module 20 includes a first signal input terminal A1 electrically connected to the clock signal line 101, a second signal input terminal A2 electrically connected to the data signal line 102 and a signal output terminal A3 electrically connected to the display drive circuit 30.

In the display panel, the first switch 41 is disposed between the first signal input terminal A1 and the clock signal line 101 with a first control terminal B1 of the first switch 41 being electrically connected to a first control signal line 51, and the second switch 42 is disposed between the second signal input terminal A2 and the data signal line 102 with a second control terminal C1 of the second switch 42 being electrically connected to a second control signal line 52.

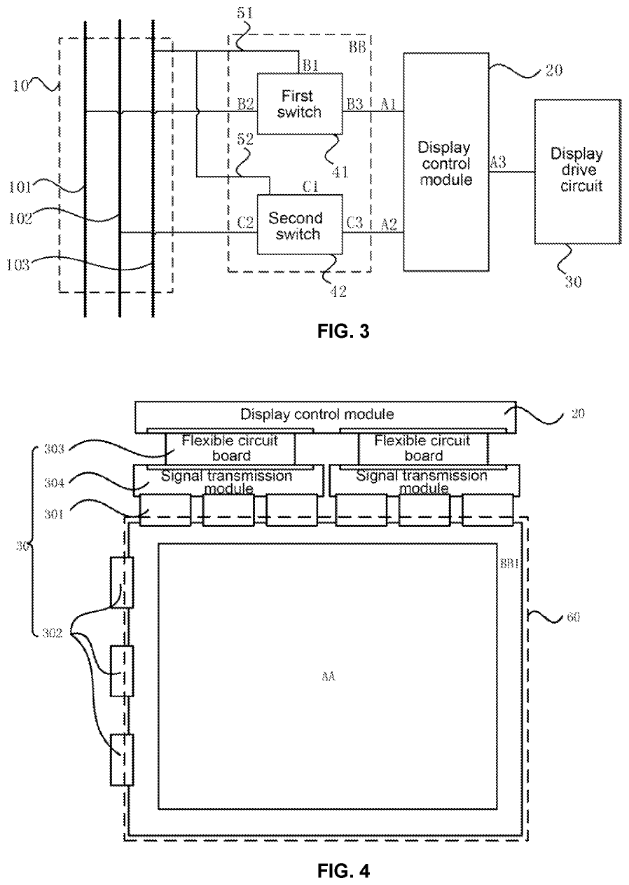

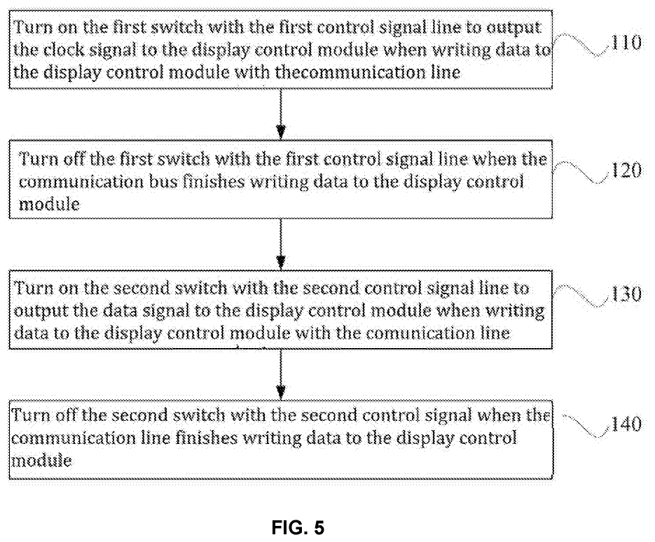

The control circuit of the display panel includes the first switch 41, and the first switch 41 is connected in series between the first signal input terminal A1 and the clock signal line 101 with the first control terminal B1 of the first switch 41 being electrically connected to the first control signal line 51, as shown in FIG. 1. Optionally, the control circuit of the display panel includes the second switch 42, and the second switch 42 is connected in series between the second signal input terminal A2 and the data signal line 102 with the first control terminal C1 of the second switch 42 being electrically connected to the second control signal line 52, as shown in FIG. 2. Optionally, the control circuit of the display panel includes both the first switch 41 and the second switch 42, and the first switch 41 is connected in series between the first signal input terminal A1 and the clock signal line 101 with the first control terminal B1 of the first switch 41 being electrically connected to the first control signal line 51, while the second switch 42 is connected in series between the second signal input terminal A2 and the data signal line 102 with the second control terminal C1 of the second switch 42 being electrically connected to the second control signal line 52, as shown in FIG. 3.

Referring to FIG. 1, with the first switch 41 being disposed between the first signal input terminal A1 and the clock signal line 101 and the second switch 42 being disposed between the second signal input terminal A2 and the data signal line 102, when writing data to the display control module 20 by the communication bus 10, the first switch 41 and the second switch 42 are controlled to connect the communication bus 10 with the display control module 20 so that data is written to the display control module 20 by the communication bus 10. When the communication bus 10 finishes writing data to the display control module 20, the first switch 41 and the second switch 42 are controlled to disconnect the communication bus 10 from the display control module 20 so as to avoid the phenomena that resistors and capacitors connected to the communication bus 10 affect the control of the display control module 20 over the display drive circuit 30 and further cause the display panel to work abnormally or even stop working.

Optionally, the communication bus 10 includes a two-wire serial bus, the clock signal line 101 includes a serial clock signal line, and the data signal line 102 includes a serial data signal line. The two-wire serial bus is electrically connected to the display control module 20 through the serial clock signal line and the serial data signal line, and is used to write data to the display control module 20 through the serial clock signal line and the serial data signal line, so that preset parameters in the display control module 20 is adjusted. When the two-wire serial bus is employed to perform data transmission, the data transmission may be achieved through the serial clock signal line and the serial data signal line. Accordingly, the circuit structure is simple and the occupied space is small, and the number of pins of the display control module 20 connected to the communication bus 10 is reduced.

Optionally, referring to FIG. 1, the first switch 41 and the second switch 42 are disposed in a non-display area BB of the display panel. Exemplarily, the non-display area BB of the display panel may include a fan-out area for cabling. The fan-out area includes a plurality of switches. Referring to FIG. 2, switches in the fan-out area BB1 are used as the first switch 41 and the second switch 42. Although no component is added in the display panel, the communication bus 10 is capable of writing data to the display control module 20, and the connection state between the communication bus 10 and the display control module 20 is controlled by the first switch 41 and the second switch 42 in the fan-out area of the display panel when the data writing is completed. Therefore, the communication bus 10 is capable of writing data to the display control module 20, and the phenomena that after the communication bus 10 finishes writing data to the display control module 20, resistors and capacitors connected to the communication bus 10 affect the control of the display control module 20 over the display drive circuit 30 and further cause the display panel to work abnormally or even stop working, is avoided.

Exemplarily, referring to FIG. 1, the control circuit of the display panel includes the first switch 41 and the second switch 42. The first switch 41 includes the first control terminal B1, a first input terminal B2 electrically connected to the clock signal line 101 and a first output terminal B3 electrically connected to the first signal input terminal A1. The first switch 41 is configured to control the connection state between the first input terminal B2 and the first output terminal B3 according to a control signal of the first control terminal B1. The second switch 42 includes the first control terminal C1, a second input terminal C2 electrically connected to the data signal line 102 and a second output terminal C3 electrically connected to the second signal input terminal A2. The second switch 42 is configured to control the connection state between the second input terminal C2 and the second output terminal C3 according to a control signal of the second control terminal C1.

Exemplarily, the first switch 41 and the second switch 42 each include an insulated gate field effect transistor (IGFET). In this case, each of the first control terminal B1 and the second control terminal C1 is the gate of the IGFET, the first input terminal B2 and the first output terminal B3 are the source and the drain of the IGFET respectively, and the second input terminal C2 and the second output terminal C3 are the source and the drain of the IGFET respectively. The first switch 41 is configured to control, based on the control signal of the first control terminal B1 (e.g., a level signal), the connection state between the first input terminal B2 and the first output terminal B3, that is, control the connection state between the clock signal line 101 and the first signal input terminal A1 of the display control module 20. The second switch 42 is configured to control, based on the control signal of the second control terminal C1 (e.g., a level signal), the connection state between the second input terminal C2 and the second output terminal C3, that is, control the connection state between the data signal line 102 and the second signal input terminal A2 of the display control module 20.

Optionally, as shown in FIG. 1, the first switch 41 is disposed between the first signal input terminal A1 and the clock signal line 101 with the first control terminal B1 of the first switch 41 being electrically connected to the first control signal line 51, while the second switch 42 is disposed between the second signal input terminal A2 and the data signal line 102 with the second control terminal C1 of the second switch 42 being electrically connected to the second control signal line 52. Optionally, the first control signal line 51 is electrically connected to the second control signal line 52, that is, the first control signal line 51 and the second control signal line 52 are capable of causing the first switch 41 and the second switch 42 to be turned on or off simultaneously. By controlling the first switch 41 and the second switch 42 to be turned on simultaneously, the clock signal line 101 and the data signal line 102 are controlled to write data to the display control module 20 simultaneously through the first switch 41 and the second switch 42. Alternatively, when the communication bus 10 finishes writing data to the display control module 20, the first switch 41 and the second switch 42 are controlled to be turned off simultaneously. Exemplarily, the communication bus 10 further includes a write protection line 103. The write protection line 103 may be electrically connected to the first control signal line 51 and the second control signal line 52, so that the write protection line 103 in the communication bus 10 can be used to control the first switch 41 and the second switch 42 without adding any additional wires.

FIG. 2 is a schematic structural diagram of a display device according to an embodiment of the present disclosure. The display device includes the control circuit (not shown) of the display panel of the above embodiments. As shown in FIG. 2, the display device further includes a display panel 60 and the display drive circuit 30. The display drive circuit 30 includes a plurality of source drive modules (also referred to as source drive circuits) 301 and a plurality of gate drive modules (also referred to as gate drive circuits) 302. Each of the plurality of source drive modules 301 includes a plurality of input terminals electrically connected to the display control module 20 and a plurality of output terminals. The display panel 60 includes a display area AA and a non-display area, and part of the output terminals of the plurality of source drive modules are electrically connected to corresponding gate drive modules 302 through wires in the non-display area of the display panel 60 (for example, wires in the fan-out area BB1).

Exemplarily, each of the source drive modules 301 is configured to obtain data signals through the input terminals electrically connected to the display control module 20, and is electrically connected to sources of thin film transistors (TFTs) in the display panel 60 through part of the output terminals so as to transmit the data signals to pixel units corresponding to the TFTs. Each of the source drive modules 301 is further configured to obtain scanning signals provided by the display control module 20 through part of the input terminals, and is electrically connected to the gate drive modules 302 through the remaining output terminals other than the output terminals electrically connected to sources of the TFTs in the display panel 60, so as to provide the scanning signals to the gate drive modules 302. Each of the gate drive modules 302 is electrically connected to gates of the TFTs in the display panel 60, so that the gates of the TFTs determine whether to turn on the pixel units according to the scanning signals. Exemplarily, part of the output terminals of each of the plurality of source drive modules 301 are electrically connected to corresponding gate drive modules 302 through wires (for example, wires in the foregoing fan-out area BB1) in the non-display area of the display panel 60.

Optionally, the display drive circuit 30 further includes a plurality of flexible circuit boards 303 connected in series between the display control module 20 and the source drive modules 301. Exemplarily, in FIG. 2, the display drive circuit 30 includes two flexible circuit boards 303. The display control module 20 is electrically connected to the source drive modules 301 through the flexible circuit boards 303, and transmits electrical signals to the source drive modules 301 through the flexible circuit boards 303. The flexible circuit boards 303 can reduce the size of the non-display area of the display panel 60, and a narrow frame can be achieved for the display panel 60.

Optionally, the display drive circuit 30 further includes at least one signal transmission module (also referred to as signal transmission circuit) 304 connected in series between the display control module 20 and the source drive modules 301. Exemplarily, in FIG. 2, the display drive circuit 30 includes two signal transmission modules 304. Exemplarily, each of the signal transmission modules 304 include a printed circuit board, and when the display control module 20 is electrically connected to the source drive modules 301 through the flexible circuit boards 303, the use of the signal transmission modules 304 (for example, printed circuit boards) can eliminate the difference between the number of pins of the flexible circuit boards 303 and the number of pins of the source drive modules 301 so that the flexible circuit boards 303 can be electrically connected to the source drive modules 301.

FIG. 3 is a schematic flowchart of a control method of a display device according to an embodiment of the present disclosure. The control method is applied to control the display device and can be implemented by the control circuit of the display panel provided by the above embodiments.

In step 110, when writing data to the display control module by the communication bus, the first switch is controlled to be turned on with the first control signal line, so as to output a clock signal to the display control module.

When the communication bus needs to write data to the display control module to adjust the preset parameters of the display control module, the first switch is turned on by controlling the first control terminal of the first switch with the first control signal line, so that the clock signal line in the communication bus outputs the clock signal to the first input terminal of the display control module.

In step 120, when the communication bus finishes writing data to the display control module, the first switch is controlled to be turned off with the first control signal line.

When the communication bus finishes writing data to the display control module, the first switch is turned off by controlling the first control terminal of the first switch with the first control signal line. Therefore, the following phenomena is avoided: resistors and capacitors electrically connected to the clock signal line in the communication bus affect the control of the display control module over the display drive circuit, and further cause the display panel to work abnormally or even stop working.

In step 130, when writing data to the display control module by the communication bus, the second switch is controlled to be turned on with the second control signal line, so as to output a data signal to the display control module.

When the communication bus needs to write data to the display control module to adjust the preset parameters of the display control module, the second switch is turned on by controlling the second control terminal of the second switch with the second control signal line, so that the data signal line in the communication bus outputs the data signal to the second input terminal of the display control module.

In step 140, when the communication bus finishes writing data to the display control module, the second switch is controlled to be turned off with the second control signal line.

When the communication bus finishes writing data to the display control module, the second switch is turned off by controlling the second control terminal of the second switch with the second control signal line. Therefore, the following phenomena is avoided: resistors and capacitors electrically connected to the data signal line in the communication bus affect the control of the display control module over the display drive circuit, and further cause the display panel to work abnormally or even stop working.

The control circuit of the display panel includes the first switch; or includes the second switch; or includes both the first switch and the second switch. The above steps 110˜140 merely illustrate the control method of the display device when the control circuit of the display panel includes both the first switch and the second switch. When the control circuit of the display panel includes only the first switch, the control method of the display device may include step 110 and step 120. When the control circuit of the display panel includes only the second switch, the control method of the display device may include step 130 and step 140.

According to the present embodiment, the communication bus includes the clock signal line and the data signal line. The display control module includes the first signal input terminal electrically connected to the clock signal line, the second signal input terminal electrically connected to the data signal line and the signal output terminal electrically connected to the display drive circuit. The first switch is disposed between the first signal input terminal and the clock signal line and the control terminal of the first switch is electrically connected to the first control signal line, while the second switch is disposed between the second signal input terminal and the data signal line and the control terminal of the second switch is electrically connected to the second control signal line; or the first switch is disposed between the first signal input terminal and the clock signal line and the control terminal of the first switch is electrically connected to the first control signal line, while the second switch is disposed between the second signal input terminal and the data signal line and the control terminal of the second switch is electrically connected to the second control signal line. The first switch can be used to control connection and disconnection between the clock signal line in the communication bus and the display control module, and the second switch can be used to control connection and disconnection between the data signal line in the communication bus and the display control module. That is, the first switch and the second switch are used to cut off the communication between the communication bus and the display control module after the communication bus finishes writing data to the display panel. Therefore, the following phenomena is avoided: part of the resistors and capacitors on the system board affect, through the communication bus, the control of the drive chip over the display panel, and further cause the display panel to work abnormally or even stop working.

### INDUSTRIAL APPLICABILITY

The control circuit of the display panel, the display device and the control method thereof provided by the present disclosure avoid the following phenomena: resistors and capacitors connected to a communication bus affect the control of the display control module over the display drive circuit, and further cause the display panel to work abnormally or even stop working.

What is claimed is:

1. A control circuit of a display panel, comprising: a communication bus, a display control circuit and at least one of a first switch and a second switch, wherein
the communication bus comprises a clock signal line and a data signal line;
the display control circuit has a first signal input terminal, a second signal input terminal and a signal output terminal, wherein the first signal input terminal is electrically connected to the clock signal line, the second signal input terminal is electrically connected to the data signal line, and the signal output terminal is electrically connected to a display drive circuit; and
the first switch is disposed between the first signal input terminal and the clock signal line with a first control terminal of the first switch being electrically connected to a first control signal line, and the second switch is disposed between the second signal input terminal and the data signal line with a second control terminal of the second switch being electrically connected to a second control signal line.

2. The control circuit according to claim 1, wherein the communication bus comprises a two-wire serial bus, the clock signal line comprises a serial clock signal line, and the data signal line comprises a serial data signal line.

3. The control circuit according to claim 1, wherein the first switch and the second switch are disposed in a non-display area of the display panel.

4. The control circuit according to claim 1, wherein the first switch comprises the first control terminal, a first input terminal and a first output terminal, the first input terminal is electrically connected to the clock signal line, the first output terminal is electrically connected to the first signal input terminal, and the first switch is configured to control a connection state between the first input terminal and the first output terminal according to a control signal of the first control terminal; and
the second switch comprises the second control terminal, a second input terminal and a second output terminal, wherein the second input terminal is electrically connected to the data signal line, the second output terminal is electrically connected to the second signal input terminal, and the second switch is configured to control a connection state between the second input terminal and the second output terminal according to a control signal of the second control terminal.

5. The control circuit according to claim 1, wherein the first control signal line is electrically connected to the second control signal line.

6. The control circuit according to claim 5, wherein the communication bus further comprises a write protection line electrically connected to the first control signal line and the second control signal line separately.

7. A display device, comprising: a display panel, a control circuit of the display panel and a display drive circuit, wherein
the control circuit of the display panel comprises a communication bus, a display control circuit and at least one of a first switch and a second switch, wherein the communication bus comprises a clock signal line and a data signal line; the display control circuit has a first signal input terminal, a second signal input terminal and a signal output terminal, wherein the first signal input terminal is electrically connected to the clock signal line, the second signal input terminal is electrically connected to the data signal line, and the signal output terminal is electrically connected to the display drive circuit; and the first switch is disposed between the first signal input terminal and the clock signal line with a first control terminal of the first switch being electrically connected to a first control signal line, and the second switch is disposed between the second signal input terminal and the data signal line with a second control terminal of the second switch being electrically connected to a second control signal line; and
the display drive circuit comprises a plurality of source drive circuits and a plurality of gate drive circuits,
wherein each of the plurality of source drive circuits has a plurality of input terminals and a plurality of output terminals, wherein the plurality of input terminals of each of the plurality of source drive circuits are electrically connected to the display control circuit, and
a part of output terminals of each of the plurality of source drive circuits are electrically connected to a corresponding gate drive circuit through wires in a non-display area of the display panel.

8. The display device according to claim 7, wherein the display drive circuit further comprises a plurality of flexible circuit boards connected in series between the display control circuit and the plurality of source drive circuits.

9. The display device according to claim 7, wherein the display drive circuit further comprises at least one signal transmission circuit connected in series between the display control circuit and the plurality of source drive circuits.

10. The display device according to claim 7, wherein the communication bus comprises a two-wire serial bus, the clock signal line comprises a serial clock signal line, and the data signal line comprises a serial data signal line.

11. The display device according to claim 7, wherein the first switch and the second switch are disposed in the non-display area of the display panel.

12. The display device according to claim 7, wherein the first switch has the first control terminal, a first input terminal and a first output terminal, wherein the first input terminal is electrically connected to the clock signal line, the first output terminal is electrically connected to the first signal input terminal, and the first switch is configured to control a connection state between the first input terminal and the first output terminal according to a control signal of the first control terminal; and
the second switch has the second control terminal, a second input terminal and a second output terminal, wherein the second input terminal is electrically connected to the data signal line, the second output terminal is electrically connected to the second signal input terminal, and the second switch is configured to control a connection state between the second input terminal and the second output terminal according to a control signal of the second control terminal.

13. The display device according to claim 7, wherein the first control signal line is electrically connected to the second control signal line.

14. The display device according to claim 7, wherein the communication bus further comprises a write protection line electrically connected to the first control signal line and the second control signal line separately.

15. A control method of a display device, wherein the display device comprises a display panel, a control circuit of the display panel and a display drive circuit, wherein
the control circuit of the display panel comprises a communication bus, a display control circuit and at least one of a first switch and a second switch, wherein the communication bus comprises a clock signal line and a data signal line; the display control circuit has a first signal input terminal, a second signal input terminal and a signal output terminal, wherein the first signal input terminal is electrically connected to the clock signal line, the second signal input terminal is electrically connected to the data signal line, and the signal output terminal is electrically connected to the display drive circuit; and the first switch is disposed between the first signal input terminal and the clock signal line with a first control terminal of the first switch being electrically connected to a first control signal line, and the second switch is disposed between the second signal input terminal and the data signal line with a second control terminal of the second switch being electrically connected to a second control signal line;
the display drive circuit comprises a plurality of source drive circuits and a plurality of gate drive circuits, wherein each of the plurality of source drive circuits has a plurality of input terminals and a plurality of output terminals, the plurality of input terminals of each of the plurality of source drive circuits are electrically connected to the display control circuit, and a part of output terminals of each of the plurality of source drive circuits are electrically connected to a corresponding gate drive circuit through wires in a non-display area of the display panel;
the control method comprises at least one of the following operations:
when writing data to the display control circuit by the communication bus, controlling the first switch to be turned on with the first control signal line so as to output a clock signal to the display control circuit; and controlling the first switch to be turned off with the first control signal line when the communication bus finishes writing data to the display control circuit; and
when writing data to the display control circuit by the communication bus, controlling the second switch to be turned on with the second control signal line so as to output a data signal to the display control circuit; and controlling the second switch to be turned off with the second control signal line when the communication bus finishes writing data to the display control circuit.

16. The method of claim 15, wherein the display drive circuit further comprises a plurality of flexible circuit boards connected in series between the display control circuit and plurality of source drive circuits.

17. The method according to claim 15, wherein the display drive circuit further comprises at least one signal transmission circuit connected in series between the display control circuit and the plurality of source drive circuits.

18. The method according to claim 15, wherein the first switch has the first control terminal, a first input terminal and a first output terminal, wherein the first input terminal is electrically connected to the clock signal line, the first output terminal is electrically connected to the first signal input terminal, and the first switch is configured to control a connection state between the first input terminal and the first output terminal according to a control signal of the first control terminal; and
the second switch has the second control terminal, a second input terminal and a second output terminal, wherein the second input terminal is electrically connected to the data signal line, the second output terminal is electrically connected to the second signal input terminal, and the second switch is configured to control a connection state between the second input terminal and the second output terminal according to a control signal of the second control terminal.

19. The method according to claim 15, wherein the first control signal line is electrically connected to the second control signal line.

20. The control circuit of a display panel according to claim 1, wherein
the first switch and the second switch each comprises an insulated gate field effect transistor IGFET, wherein the first control terminal of the first switch and the second control terminal of the second switch are gates of the IGFETs, a first input terminal of the first switch and a first output terminal of the first switch are a source of the IGFET and a drain of the IGFET respectively, and a second input terminal of the second switch and a second output terminal of the second switch are a source of the IGFET and a drain of the IGFET respectively.
